(19) United States
(12) Patent Application Publication
(10) Pub. No.: US 2015/0117153 A1
(43) Pub. Date: Apr. 30, 2015

(54) ADAPTIVE TRANSMITTER CLUSTER AREA FOR ULTRASONIC LOCATIONING SYSTEM

(71) Applicant: SYMBOL TECHNOLOGIES, INC., Schaumburg, IL (US)

(72) Inventor: RUSSELL E. CALVARESE, Stony Brook, NY (US)

(73) Assignee: SYMBOL TECHNOLOGIES, INC., Schaumburg, IL (US)

(21) Appl. No.: 14/064,035

(22) Filed: Oct. 25, 2013

(51) Int. Cl. G01S 11/14

(52) U.S. Cl. CPC G01S 11/14
USPC 367/117

(57) ABSTRACT

A system and method for ultrasonic locationing of a mobile device within an environment using an adaptive transmitter cluster area includes a first step of providing a plurality of fixed ultrasonic transmitters operable to be activated to provide active clusters of transmitters to service mobile devices within a predefined coverage area of the environment. A next step includes transmitting ultrasonic bursts by the transmitters to mobile communication devices to be located within the environment. A next step includes determining a location of mobile devices within the environment using the ultrasonic bursts. A next step includes establishing a density of active clusters within the environment. A next step includes adapting an area of each cluster in response to the active cluster density.

### BACKGROUND

An ultrasonic receiver can be used to determine its location with reference to one or more ultrasonic transmitters using techniques known in the art such as measuring time-of-flight or signal strength of the transmitter signals and using triangulation, trilateration, and the like, as have been used in radio frequency locationing systems. For example, a mobile device with an ultrasonic receiver can be located within a retail store, factory, warehouse, or other indoor environment. Fixed ultrasonic transmitter(s) in known positions can transmit ultrasonic signals in a short burst which can be received by an ultrasonic transducer (audio microphone) in the ultrasonic receiver. Timing or signal strength measurements of these signals can then be used to establish the location of the receiver. Several ultrasonic transmitters can be distributed within the environment to provide a more accurate location of a particular mobile device.

However, having many mobile devices trying to establish their position within the environment, and interacting with all the transmitters in the environment cannot be done simultaneously since separate transmitter signals would interfere with each other. As a result, when scaling ultrasonic locationing systems to larger spaces by adding more transmitters, it becomes difficult to keep the location update (refresh) rate at a reasonable level.

One solution for this problem uses synchronized time-slicing of transmitters in ultrasonic transmitter clusters such that adjacent clusters don't interfere with each other. For example, transmitters in a cluster can send an ultrasonic burst and then wait for any reflected echoes to settle before subsequent ultrasonic bursts are sent by that or other transmitters. This technique solves the interference problem, but mobile devices can then only update their location at their specific time-slice, i.e. they will have a poor location update rate. For example, in a large retail space, with dozens of transmitters, position update rate can degrade to the many tens of seconds.

Another solution for this problem is for transmitters within a cluster to use different frequency bursts that can be discriminated by the mobile devices. This solution would use more ultrasonic bandwidth, where a larger range of ultrasonic frequencies can be used. However, today's mobile devices have a very limited ability to hear ultrasonic frequencies, typically between 19-22 kHz. Therefore, the only way to expand usable bandwidth would be to replace the existing audio circuitry of the mobile device to operate on higher frequencies, which is cost prohibitive. Alternatively, the usable frequencies could be expanded down into the audio range, but this would become disruptive to the users.

Another solution for this scaling problem is to dynamically deactivate clusters that don't have devices in their coverage area. This approach works well when the number of active clusters is not excessive. However, when there is at least one device to be located in every cluster coverage area, this approach provides no advantage. Although this approach is still a good first approach, since no accuracy is lost for many scenarios, it is not comprehensive.

Another solution for the scaling problem is to dynamically switch to a received signal strength indicators (RSSI) based mode when the number of active clusters becomes too great for an acceptable position update rate. While this is a very reliable approach, it trades excessive accuracy.

Accordingly, there is a need for a technique to provide a good location update rate for a mobile device in an indoor environment while eliminating the aforementioned issues. Furthermore, other desirable features and characteristics of the present invention will become apparent from the subsequent detailed description and the appended claims, taken in conjunction with the accompanying drawings and the foregoing background.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of an ultrasonic locationing system, in accordance with some embodiments of the present invention.

FIG. 2 is a top view of an indoor environment with transmitters, in accordance with some embodiments of the present invention.

FIG. 3 is a graphical representation of position update rate improvements, in accordance with some embodiments of the present invention.

FIG. 4 is a flow diagram illustrating a method, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, an improved technique is described to locate a mobile device in an indoor environment while reducing problems associated with a poor position update rate, as will be detailed below.

The device to be located can include a wide variety of business and consumer electronic platforms such as cellular radio telephones, mobile stations, mobile units, mobile nodes, user equipment, subscriber equipment, subscriber stations, mobile computers, access terminals, remote terminals, terminal equipment, cordless handsets, gaming devices, smart phones, personal computers, and personal digital assistants, and the like, all referred to herein as a communication device. Each device comprises a processor that can be further coupled to a keypad, a speaker, a microphone, audio circuitry, a display, signal processors, and other features, as are known in the art and therefore not shown or described in detail for the sake of brevity.

Various entities are adapted to support the inventive concepts of the embodiments of the present invention. Those skilled in the art will recognize that the drawings herein do not depict all of the equipment necessary for system to operate but only those system components and logical entities particularly relevant to the description of embodiments herein. For example, routers, controllers, servers, switches, access points/ports, and wireless clients can all includes separate communication interfaces, transceivers, memories, and the like, all under control of a processor. In general, components such as processors, transceivers, memories, and interfaces are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, and/or expressed using messaging logic flow diagrams.

Thus, given an algorithm, a logic flow, a messaging/signaling flow, and/or a protocol specification, those skilled in the art are aware of the many design and development techniques available to implement one or more processors that perform the given logic. Therefore, the entities shown represent a system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the memory and control aspects of the present invention may be implemented in any of the devices listed above or distributed across such components.

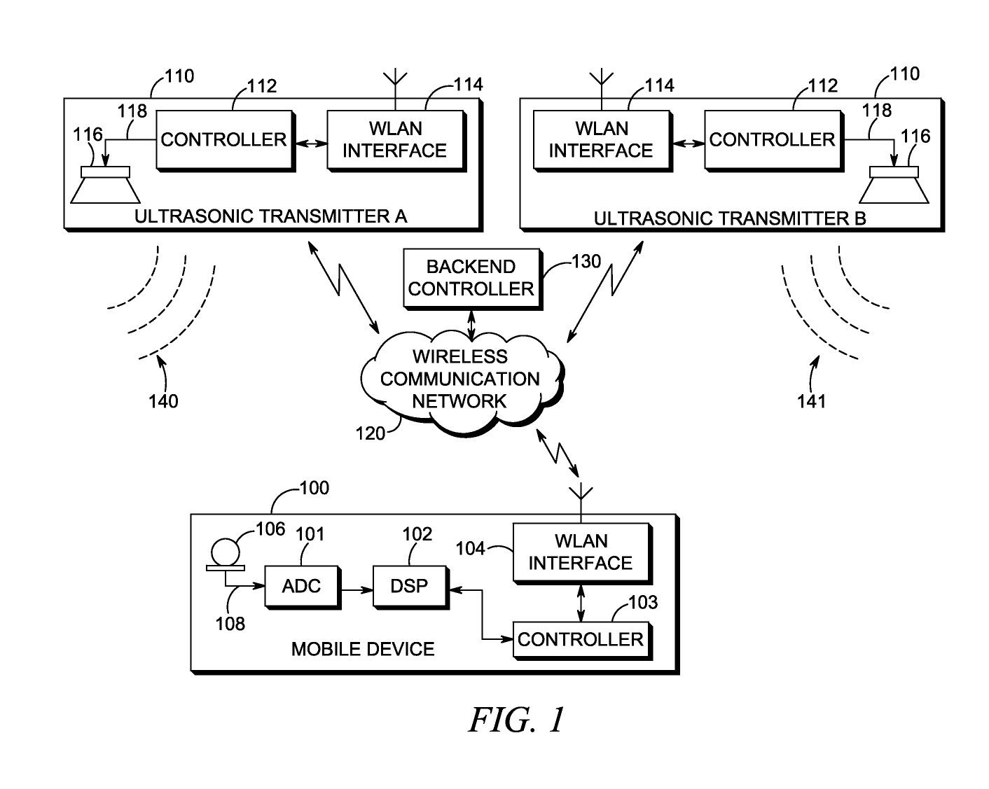

FIG. 1 is a block diagram of an ultrasonic locationing system, in accordance with the present invention. A plurality of ultrasonic transponders such as a piezoelectric speaker or transmitter 116 can be implemented within the environment. Each transmitter can send a short burst of ultrasonic sound (e.g. 140, 141) within the environment. The transmitters can be affixed to a ceiling of the environment and oriented towards a floor of the environment to provide a limited region for mobile communication devices to receive the ultrasonic burst. The mobile device 100 can include a digital signal processor 102 to process the ultrasonic bursts 140, 141 received by a transponder such as a microphone 106, and specifically the timing of the signals 140, 141 from the ultrasonic transmitters 116 for determining its location at repeated intervals.

The microphone 106 provides electrical signals 108 to receiver circuitry including a signal processor 102. It is envisioned that the mobile device can use existing audio circuitry having typical sampling frequencies of 44.1 kHz, which is a very common sampling frequency for commercial audio devices, which relates to a 22.05 kHz usable upper frequency limit for processing audio signals. It is envisioned that the mobile device receiver circuitry is implemented in the digital domain using an analog-to-digital converter 101 coupled to a digital signal processor 102, for example. It should be recognized that other components, including amplifiers, digital filters, and the like, are not shown for the sake of simplicity of the drawings. For example, the microphone signals 108 can be amplified in an audio amplifier after the microphone 106.

The processor 102 can also be coupled to a controller 103 and wireless local area network interface 104 for wireless communication with other devices, and controllers 130 in the communication network 120. Each transmitter 110 can be coupled to its own controller 112 and wireless local area network interface 114 for wireless communication with the server or backend controller 130 in the communication network 120. Alternatively, either or both of the mobile device 100 and transmitters 110 could be connected to the communication network 120 through a wireless local area network connection (as shown) or a wired interface connection (not represented), such as an Ethernet interface connection. The wireless communication network 120 can include local and wide-area wireless networks, wired networks, or other IEEE 802.11 wireless communication systems, including virtual and extended virtual networks. However, it should be recognized that the present invention can also be applied to other wireless communication systems. For example, the description that follows can apply to one or more communication networks that are IEEE 802.xx-based, employing wireless technologies such as IEEE's 802.11, 802.16, or 802.20, modified to implement embodiments of the present invention. The protocols and messaging needed to establish such networks are known in the art and will not be presented here for the sake of brevity.

The controller 112 of each ultrasonic transmitter 110 provides the speaker 116 with a frequency tone to emit in an ultrasonic burst 140, 141 at predetermined times to a communication device 100 located within the environment. The predetermined times can be scheduled by the backend controller 130 to avoid interference between nearby transmitters. In other words, the transmitters are scheduled far enough apart in time such that any device within the locality of that transmitter will receive and report that burst back to a locationing engine before any other transmitter has the chance to emit its burst and be detected by that device. The speaker will typically broadcast the burst with a duration of about two milliseconds, with bursts separated by about 200 milliseconds to allow reverberations to die down. The particular amplitude, frequency, and timing between subsequent bursts to be used by each transmitter 110 can be directed by a scheduler in the backend controller 130 via the network 120. The transmitters are configured to have usable output across about a 19-22 kHz frequency range.

The processor 102 of the mobile device 100 is operable to discern the frequency and timing of tone received in its microphone signal 108. The tone is broadcast at a frequency within the frequency range of about 19-22 kHz to enable the existing mobile device processor 102 analyze the burst in the frequency domain to detect the tone. The 19-22 kHz range has been chosen such that the existing audio circuitry of the mobile device will be able to detect ultrasonic tones without any users within the environment hearing the tones. In addition, it is envisioned that there is little audio noise in the range of 19-22 kHz to interfere with the ultrasonic tones.

It is envisioned that the processor 102 of the mobile device will use a Fast Fourier Transform (FFT) to discern the burst tones for timing and or received signal strength indicators (RSSI) measurements in the frequency domain. In particular, a Goertzel algorithm can be used to detect timing of the receipt of the tone to be used for flight time measurements. In practice, the mobile device can simply measure the time when it receives bursts for two or more different transmitters, and supply this timing information to the backend controller. A location analytics engine in the backend controller 130 can receive the timing information from the mobile device, and subtract the time that the transmitter was directed to emit the burst, in order to determine the flight time of each burst to the mobile device. Given the flight time of different transmitter signals to the mobile device along with the known positions of the fixed transmitters, the location analytics engine in the back end controller can determine a location of the mobile device using known trilateration techniques, for example. In another scenario, the mobile device can measure the signal strength of received tones for two or more different transmitters, and supply signal strength and timing information to the backend controller. The back end controller, knowing the time that its scheduler directed each transmitter to send its burst can then determine the distance to the mobile device for each transmitter's burst, where closer transmitters producing stronger tones. Using known trilateration techniques, the location analytics engine in the backend controller can then determined the location of the mobile device. Alternatively, the mobile device can receive the time that the burst was sent from the backend controller or transmitter itself, and subtract that from the time that the mobile device received the burst, in order to determine the flight time of the burst to the mobile device. Given the flight time of different transmitter signals to the mobile device along with the known positions of the fixed transmitters, the mobile device can determine its own location.

For example, if a device's hardware has the capability to perform more accurate flight time measurements, considering that some mobile devices support more accurate/higher refresh rate modes, then the backend controller can drive transmitters to broadcast ultrasonic locationing bursts at predefined times for flight time measurements, and a flight time locationing mode can be used by a mobile device to measure the timing of those locationing tones, and if a device's hardware only has the capability to perform less accurate signal strength measurements (i.e. received signal strength indicators or RSSI), then the backend controller scheduler can drive transmitters to broadcast ultrasonic locationing bursts for signal strength measurements, and a signal strength locationing mode can be used by that device to measure the signal strength of those locationing tones.

The present invention operates within a limited ultrasonic frequency range of 19-22.05 kHz. Given that the pulse duration needs to be very short for accuracy, and due to limited smart phone capabilities, only a few different high sound pressure level (SPL) frequencies can be used before they overlap within this frequency range. Also, due to Doppler shifts that can occur with a mobile device, guard bands between specific frequencies must be used, and therefore the amount of discernible frequency tones that can be accurately recognized within this range is limited. In the ultrasonic band of interest (19 kHz to 22.05 kHz), it is only possible to distinguish four or five distinct tones while still leaving room for as much as +/−125 Hz of Doppler shift (enough margin to accommodate that which would be present from a very fast walking speed).

Each transmitter is configured to broadcast the burst over a limited coverage area or region. For unobtrusiveness and clear signaling, the transmitters can be affixed to a ceiling of the environment, where the position and coverage area of each transmitter is known and fixed, with the transmitter oriented to emit a downward burst towards a floor of the environment, such that the burst from an transmitter is focused to cover only a limited, defined floor space or region of the environment.

In practice, it has been determined that one transmitter in a typical retail environment and under typical operation can provide a coverage area of about fifty feet square. Therefore, a plurality of transmitters 110 is provided to completely cover an indoor environment, and these transmitters are spaced in a grid about fifty feet apart. A mobile device that enters the environment and associates to the wireless local area network (WLAN) of the backend controller, and is provided a software application to implement the locationing techniques described herein, in accordance with the present invention. In accordance with the present invention, each ultrasonic transmitter can emit an adjustable, higher than normal sound pressure level (SPL). This will provide an extended range signal capable of being detected by mobile devices outside of the normal fifty foot square. For example, the SPL of one transmitter can be increased enough to provide coverage over a one-hundred fifty foot square, nine times greater than normal.

For locationing purposes, the backend controller can direct specific transmitters to emit their bursts at particular times or frequencies. The present invention provides that transmitters in neighboring regions do not emit their ultrasonic burst at the same time or frequency, to avoid interference, although transmitters in non-neighboring regions can emit their ultrasonic burst at the same time or frequency if there is minimum interferences therebetween. Different frequencies, groups of frequencies, burst durations, and burst timings can be used by each transmitter. A mobile communication device can receive these tones and provide timing and/or signal strength information to the backend controller that includes a locationing engine, which can used to locate the mobile device. For example, the mobile device can transmit timing, single strength or RSSI, and possibly frequency, information about the tones it detects over the communication network 120 to a backend controller 130, which can determine the location of the mobile device based on this information and a known floor plan of the transmitter locations. In this example, it is assumed that the timing of the backend controller and mobile devices is synchronized.

Mobile devices benefit from maximum possible refresh rate of its location. During locationing, those mobile devices that are using flight time measurements are expected to have a position update rate of about every 500 mS (two updates per second for three samples—averaging 1.5 seconds). Those mobile devices that are using signal strength measurements are expected to have a position update rate of about every two seconds with three samples—averaging 6 seconds. Each communication device performs its locationing measurements needed by the backend controller using the ultrasonic locationing bursts broadcast from transmitters activated in a cluster by the backend controller.

The techniques described herein are specific to a flight time based ultrasonic positioning system but may apply to radio frequency (RF) transmitter systems as well. The present invention increases the transmit power level of transmitter ultrasonic bursts (e.g. ranging pulses) well beyond what is needed for typical locationing. As a result, the range of the ultrasonic burst is increased to give adequate signal-to-noise ratio (SNR) for a more distant mobile device to accurately locate itself.

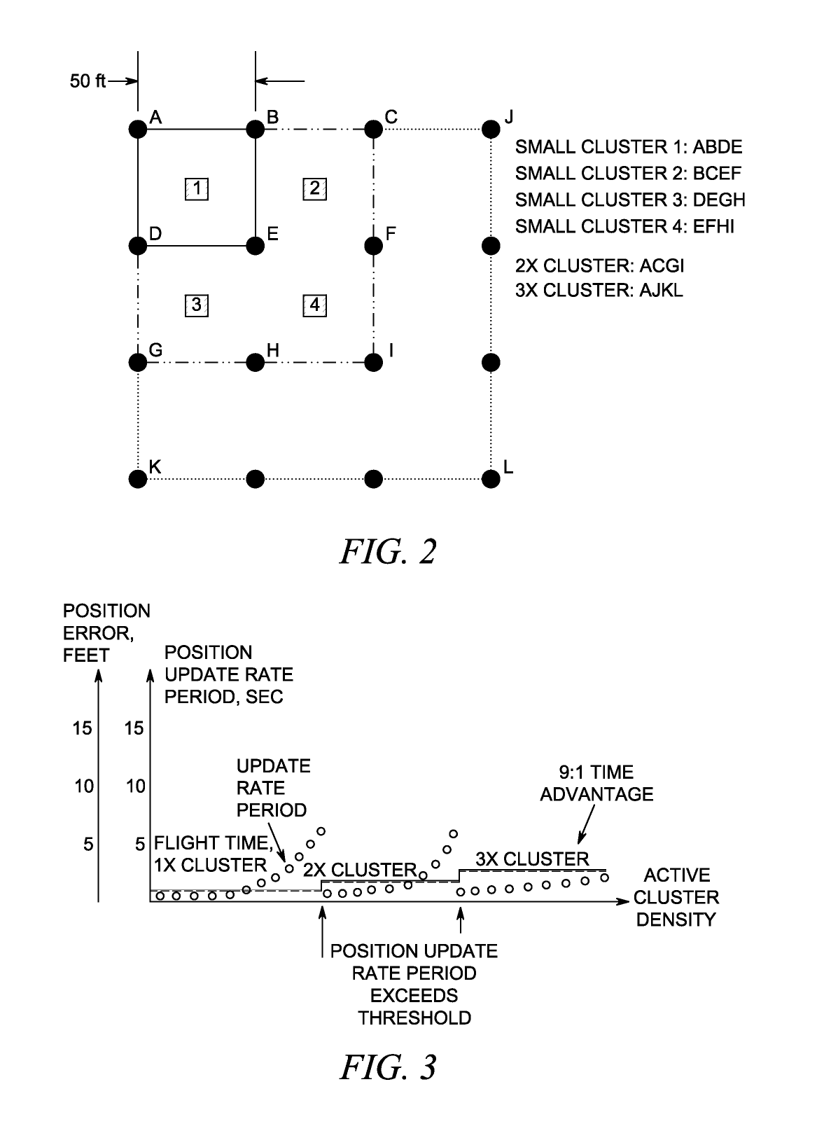

FIG. 2 illustrates a top view of a typical retail environment that includes sixteen downward-firing transmitters affixed to a ceiling of the environment. Although a rectilinear pattern of transmitter positions is shown it should be recognized that transmitters could be positioned in any irregular or regular pattern including triangular and hexagonal, for example. In typical operation, each transmitter covers a fifty foot range. To minimize interference between transmitters, the transmitters can be operated in a time-multiplex mode, and/or utilize different frequency tones.

A mobile device located within the environment needs to be near at least two transmitters, and preferably three or four transmitters, to be properly located. If a mobile device is located within nearby transmitters ABDE for example, the backend controller will activate these transmitters for proper locationing of the mobile device, i.e. these four transmitters form an active cluster—small cluster 1. Similarly, if a mobile device is present within transmitters BCEF, these four transmitters form active small cluster 2, and similarly for small cluster 3—DEGH, and small cluster 4—EFHI. The more mobile devices located within the environment, the more active clusters are formed, and the higher potential for interference between clusters.

Utilizing time-slicing between transmitters reduces the potential for interference but increases the time between bursts, resulting in longer periods between location updates for each mobile device, i.e. increased update rate period. For example, if all small clusters 1-4 are active, the scheduler of the backend controller could direct each transmitter A-I to emit its burst in sequence. If the active cluster density is too high, such as in this case, a mobile unit in one of those areas may not be able to update its location at a sufficient update rate since each transmitter will need to cycle through their assign time slices. In this case, the backend controller could deactivate small clusters 1-4 and direct transmitters ACGI to increase their SPL to expand their coverage area to a new active 2× cluster that covers four times the area, e.g. a 100 foot range, using only the four transmitters ACGI. In this way a mobile device need only wait for a four-burst cycle, instead of the previous nine-burst cycle, before being able to update its location. If the active cluster density is still too high, where a mobile unit within the 2× active cluster is not able to update its location at a sufficient update rate, the backend controller could deactivate the small or 2× clusters and direct transmitters AJKL to further increase their SPL to expand their coverage area to a new active 3× cluster that covers nine times the area, e.g. a 150 foot range.

FIG. 3 is a graphical representation of the improvement provided by the present invention. Using flight time measurements from the mobile device for locationing, if the update rate period increases too much (i.e. there are too many active transmitter clusters in one area resulting in an update rate period approaching six seconds), the controller can deactivate those transmitters in smaller clusters and activate transmitters in a larger cluster area, while also directing those same transmitter to increase their SPL to increase coverage area for the larger cluster. In this way, the locationing coverage area can be increased (with a minor degrading of accuracy), while improving the location update rate significantly. For example, an area typically covered by four small clusters can be covered by one 2× cluster if its transmitters increase their SPL to double range, resulting in a 4:1 update rate period improvement while only approximately doubling position error, i.e. from about one foot to two feet. Further, an area typically covered by nine small clusters can be covered by one 3× cluster if its transmitters increase their SPL to triple range, resulting in a 9:1 update rate period improvement while only approximately tripling position error, i.e. from about one foot to three feet. This is much better than the prior art approach of switching to an RSSI locationing mode, where the position error could approach fifteen feet for the same update rate periods.

Optionally, the transmitter can be directed to use wider pulse widths for their ultrasonic bursts when in active clusters of increased area. Wider pulses allow for more energy to be transmitted insuring a detection at a farther distance. This increases the probability of capturing all mobile devices located within a larger active cluster, although resulting in less accuracy.

In another option, when active cluster density is not a problem and mobile devices are able to refresh their location at a sufficient rate, the present invention envisions periodically activating a much larger cluster area to provide a quick location sample for devices within the environment with less time overhead. For example, a transmitter in each corner of the environment can be chosen to form one very large cluster encompassing the entire environment. These transmitters can be directed emit a very high, if not maximum SPL, in order to capture the location of all mobile devices within the environment at the expense of a long reverberation time. Advantageously, this technique provides additional position samples that can be used to increase the confidence of existing device locations, and may even capture devices that were not previously detected. As a result overall location accuracy is improved as devices move around the environment, while reducing uncertainty of individual position samples.

In the above embodiments, the present invention will adapt transmitter cluster area dependent on a density of active transmitter clusters. If the active transmitter density is too high, the location update refresh rate period can become too high, resulting in a diminished capacity of the backend controller to accurately locate and track the movements of mobile devices within the environment. This is important as the backend controller scheduler must activate/deactivate transmitters in the environment to properly service mobile device therein. If a location of a mobile device can only be established every six seconds for example, that device may have already moved to a different area and the backend controller may find itself activating the wrong transmitters/clusters. Therefore, the present invention activates larger cluster areas to increase update rate to increase locationing confidence, while only minimally increasing location error. Moreover, the error increase is less than the amount of distance a moving mobile device may cover between excessive location update periods.

The threshold to determine when the active transmitter density is too high, calling for a change in cluster area, can be determined empirically, and is dependent on and measured against one or more of the length of time and number of scheduled time-slices between active transmitters, the number of available frequencies that can be used by active transmitters, the number of mobile devices within a cluster, an interference level, and an update rate period of the mobile devices.

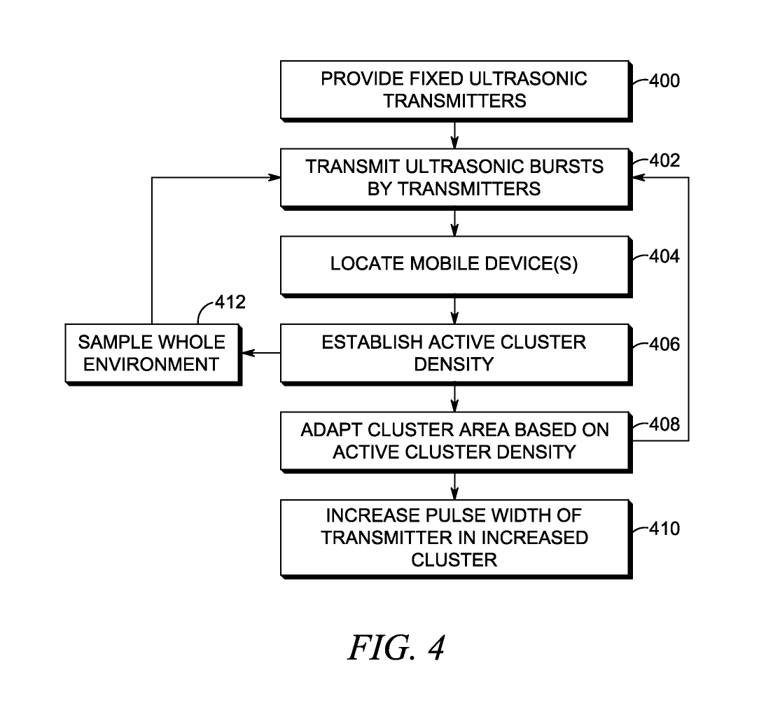

FIG. 4 is a flowchart illustrating a method for ultrasonic locationing of a mobile device within an environment using an adaptive transmitter cluster area, according to some embodiments of the present invention.

A first step 400 includes providing a plurality of fixed ultrasonic transmitters within the environment, the transmitters operable to be activated to provide active clusters of transmitters to service mobile devices within a predefined coverage area of the environment.

A next step 402 includes transmitting ultrasonic bursts by the transmitters to mobile communication devices to be located within the environment.

A next step 404 includes determining a location of mobile devices within the environment using the ultrasonic bursts.

A next step 406 includes establishing a density of active clusters within the environment.

A next step 408 includes adapting an area of each cluster in response to the active cluster density.

An optional step 410 includes increasing a pulse width of the burst when the cluster area in increased.

An optional step 412 includes periodically and temporarily increasing cluster area to provide location samples for all mobile communication devices within the environment.

Advantageously, the present invention provides an ultrasonic locationing system trades a relatively small amount of accuracy (see FIG. 3) for a much improved location update rate, while also reducing network traffic.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors or processing devices such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc Read Only Memory, an optical storage device, a magnetic storage device, a Read Only Memory, a Programmable Read Only Memory, an Erasable Programmable Read Only Memory, an Electrically Erasable Programmable Read Only Memory, and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system ultrasonic locationing of a mobile communication device within an environment using an adaptive transmitter cluster area, the system comprising:
a plurality of fixed ultrasonic transmitters within the environment, the transmitters operable to transmit ultrasonic bursts to mobile communication devices to be located within the environment, the transmitters also operable to be activated to provide active clusters of transmitters each having a predefined coverage area; and
a controller coupled to the transmitters and operable to activate transmitters for each cluster, the controller operable to determine a density of active clusters within the environment and adapt an area of each cluster in response to the active cluster density.

2. The system of claim 1, further comprising the controller locating a mobile communication device using the ultrasonic bursts; and wherein controller also adapts cluster area based on the location information.

3. The system of claim 1, wherein if the controller is operating the transmitters in clusters using the predefined cluster area, the controller is further operable to periodically and temporarily increase cluster area to provide location samples for all mobile communication devices within the environment.

4. The system of claim 1, wherein the controller directs the transmitters to increase a pulse width of the burst when the cluster area in increased.

5. The system of claim 1, wherein the transmitters are operated in a time-multiplexed manner by the controller.

6. The system of claim 1, wherein the backend controller establishes the density of active clusters with respect to at least one of the group of the length of time and number of scheduled time-slices between active transmitters.

7. The system of claim 1, wherein the backend controller establishes the density of active clusters with respect to at least one of the group of; the number of mobile communication devices within a cluster, and an update rate period of the mobile communication devices.

8. A method for ultrasonic locationing of a mobile communication device within an environment using an adaptive transmitter cluster area, the method comprising:
providing a plurality of fixed ultrasonic transmitters within the environment, the transmitters operable to be activated to provide active clusters of transmitters to service mobile communication devices within a predefined coverage area of the environment;
transmitting ultrasonic bursts by the transmitters to mobile communication devices to be located within the environment;
determining a location of mobile communication devices within the environment using the ultrasonic bursts;
establishing a density of active clusters within the environment; and
adapting an area of each cluster in response to the active cluster density.

9. The method of claim 8, wherein adapting also adapts cluster area based on the location of the mobile communication devices.

10. The method of claim 8, wherein if the transmitters are operating clusters using the predefined cluster area, further comprising periodically and temporarily increasing cluster area to provide location samples for all mobile communication devices within the environment.

11. The method of claim 8, further comprising increasing a pulse width of the burst when the cluster area in increased.

12. The method of claim 8, wherein providing includes operating the transmitters a time-multiplexed manner.

13. The method of claim 8, wherein establishing includes establishing the density of active clusters with respect to at least one of the group of; the length of time and number of scheduled time-slices between active transmitters.

14. The method of claim 8, wherein establishing includes establishing the density of active clusters with respect to at least one of the group of; the number of mobile communication devices within a cluster, and an update rate period of the mobile devices.
